(19) United States
(12) Patent Application Publication
(10) Pub. No.: US 2003/0149382 A1
(43) Pub. Date: Aug. 7, 2003

(54) Head, hair, and scalp cleansing, stimulation and massage cap

(76) Inventor: Thomas C. Waller, Calgary (CA)

Correspondence Address: BENNETT JONES, 4500 Bankers Hall East, 855 - 2nd Street SW, Calgary, AB, T2P 4K7, CA

(21) Appl. No.: 10/066,540

(22) Filed: Feb. 5, 2002

(51) Int. Cl. A61H 7/00

(52) U.S. Cl. 601/137

(57) ABSTRACT

The Invention relates generally to the fields of the cleansing, massaging and stimulation of the human head, hair and scalp. In particular, the Invention is a one-size-fits-all or relatively generically sized flexible and resilient cap-like device with affixed flexible internal protrusions or tines, for use in the cleansing, massaging and stimulation of the human head, hair and scalp. The tines may be of various shapes and disposed in various arrays or patterns, depending upon desired application.

### FIELD OF THE INVENTION

The Invention relates generally to the fields of the cleansing, massaging and stimulation of the human head, hair and scalp. In particular, the Invention, in one embodiment, is a cap-like device with affixed internal protrusions for use in the cleansing, massaging and stimulation of the head, hair and scalp.

### BACKGROUND OF THE INVENTION

The most common method of washing or cleansing the scalp and hair has been through the use of one's own hands, in conjunction with water, and soap or shampoo that is lathered and massaged by the fingers and nails against the hair and scalp.

Several implementation devices have been developed that aid in washing body parts in general. See U.S. Pat. No. 4,893,955, a therapeutic scrubbing mitten for cleansing the scalp, consisting of soft bristles in the finger portion, U.S. Pat. No. 5,924,160, a combined glove and wash cloth for cleaning, and U.S. Pat. No. 4,523,348, a nurse's mitt for washing.

Also with reference to the scalp, it is commonly understood that massage therapy is a way to treat a variety of ailments, including headaches. A number of methods and devices have been proposed to aid in head and scalp massage therapy, including manually performed hand massages, acupressure devices and vibrating massaging devices. See U.S. Pat. No. 4,308,860, a scalp massaging implement with flexible tines, that fits over a person's hand, and U.S. Pat. No. 5,768,709, a therapeutic massager glove with bristles, as examples of this type of massage aid. Also, U.S. Pat. No. 4,506,659 reveals a massaging device for the scalp, containing a pair of massaging elements. As well, U.S. Pat. No. 5,081,986 claims a massaging and combing helmet for insomnia, containing an endless belt that rubs the user's head; and U.S. Pat. No. 5,188,097 discloses a capillary massage apparatus comprised of a massage helmet with numerous knobs and an electric motor that is fastened to the user's armpits by a harness. U.S. Pat. No. 5,277,174 discloses a scalp massager comprising a helmet with contact points, and inflating pump and valve, while U.S. Pat. No. 5,421,799 provides a scalp massage device with supporting frame and vibrator mounted to the head, and U.S. Pat. No. 6,309,365 discloses a head massaging device consisting of resilient fingers.

In addition to cleansing and massaging the scalp, several methods exist for externally stimulating the scalp. By way of example, U.S. Pat. No. 4,469,092 claims a scalp stimulating system with helmet and stimulating fingers, with a vibration motor; and U.S. Pat. No. 4,765,316, a scalp stimulator comprised of a electro-mechanical system with vacuum and vibration generated within a helmet. U.S. Pat. No. 5,228,431 provides for a drug-free treatment for headaches by stimulating the scalp via a helmet and vacuum source, U.S. Pat. No. 5,454,778, provides an apparatus for stimulating blood circulation in the scalp having a vacuum and flexible tube; U.S. Pat. No. 6,228,041, a lightweight portable scalp vibrating and hair growth; and U.S. Pat. No. 5,792,174, a natural headache reliever using a cap-like device with protrusions and a pump.

### SUMMARY OF THE INVENTION

It is an object of the Invention to overcome limitations in the prior art of cleansing, massaging and stimulation techniques and devices designed for the scalp. The majority of the existing methods and devices are cumbersome, complex and involve intricate electronic or hydraulic components, and they are not practical or affordable for everyday use. The disadvantage of using one's own hands is that the massage and stimulation is not effective, use of the finger tips is tiring to the hands and may not supply adequate pressure or agitation to the head, scalp and hair to loosen dirt, oils, or skin particles from the scalp, and the use of the fingernails may scrap the scalp and cause injury to nails or scalp.

The prior art inadequately addresses the need for a less complicated solution that effectively utilizes a durable, inexpensive and easy to use implement for cleansing, massaging and stimulating the head, hair and scalp.

This Invention is comprised of a cap-like device in the form of a flexible hollow shell with a non-slip outer surface and an interior lined with rubber protrusions or “fingers”.

The invention is designed to be placed over a human head so that the human operator (who may be the subject or a helper) places the operator's fingers on the non-slip exterior of the cap-like shell, causing the protrusions or “fingers” on the inside of the shell to contact the hair and scalp, thus assisting in cleaning, massaging and stimulation of the hair, head and scalp. The Invention may also be used to scoop water and pour or drain over the subject's head to assist in washing or rinsing.

The Invention provides a simple method and means to cleanse and massage and enable better penetration of hair, massage or scalp cleaner or massage solutions and the removal of loose and dead skin and accumulated oils and dirt or other buildup, while at the same instance stimulating the head, hair and scalp. The Invention is also easy to clean and to store.

These and other objects and advantages of the Invention are apparent in the following description of embodiments of the Invention, which is not intended to limit in any way the scope or the claims of the Invention.

The described embodiments of the Invention display preferred compositions but are not intended to limit the scope of the Invention. It will be obvious to those skilled in the art that variations and modifications may be made without departing from the scope and essential elements of the Invention.

### BRIEF DESCRIPTION OF THE DRAWINGS

FIG. One (1) is a perspective view of an embodiment of the cap placed on a human subject's head in its operating position.

FIG. Two (2) is a top elevation of an embodiment of the Invention.

FIG. Three (3) is a bottom elevation of an embodiment of the Invention.

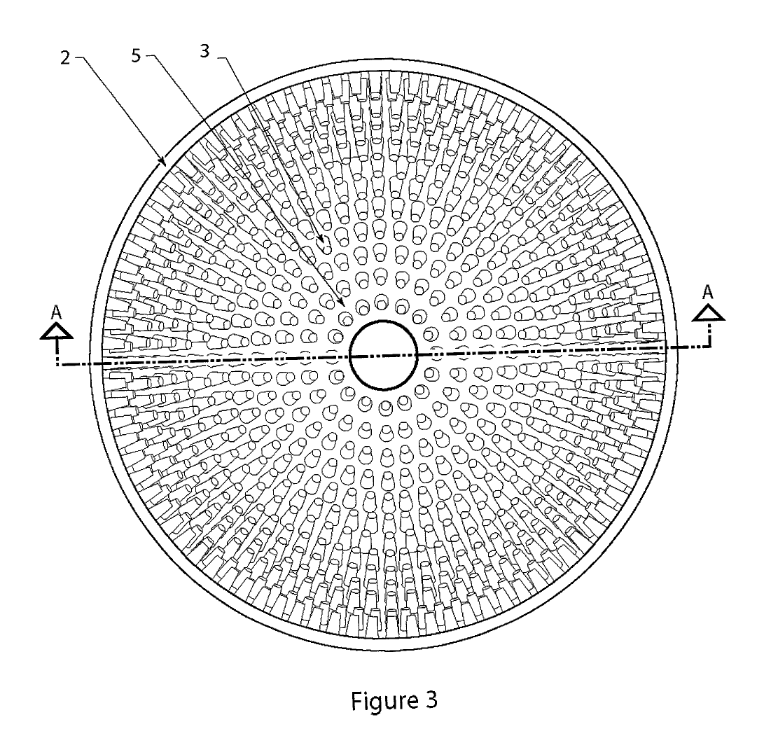

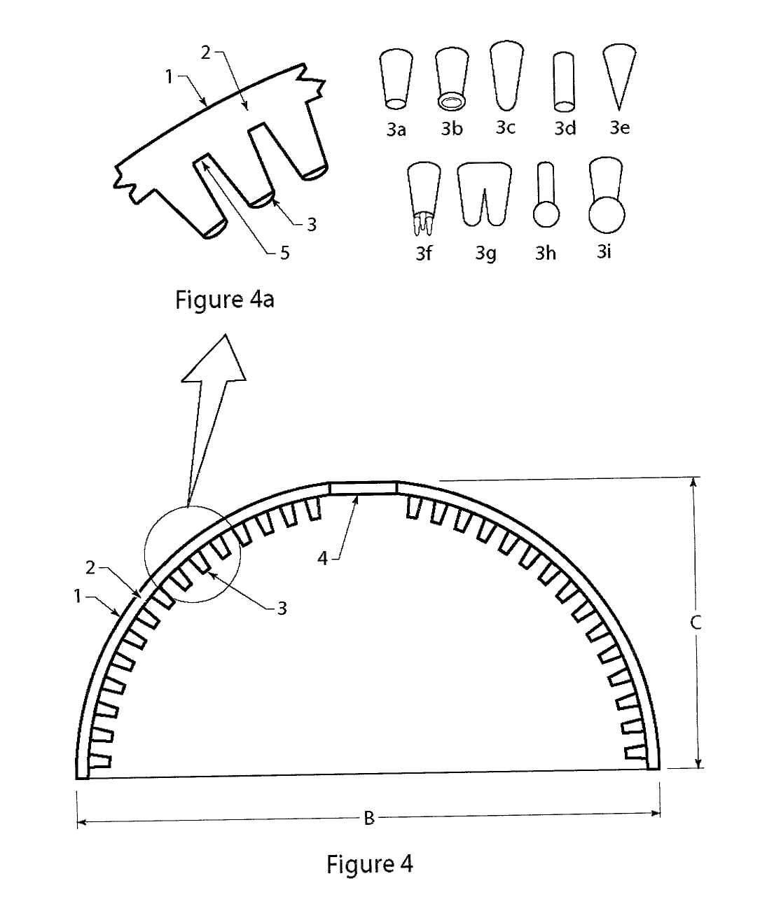

FIG. Four (4) is a cross-section of the cap (at line A in FIG. 3) showing its internal structure, and includes FIG. 4a which is an enlarged segment of same.

### DETAILED DESCRIPTION

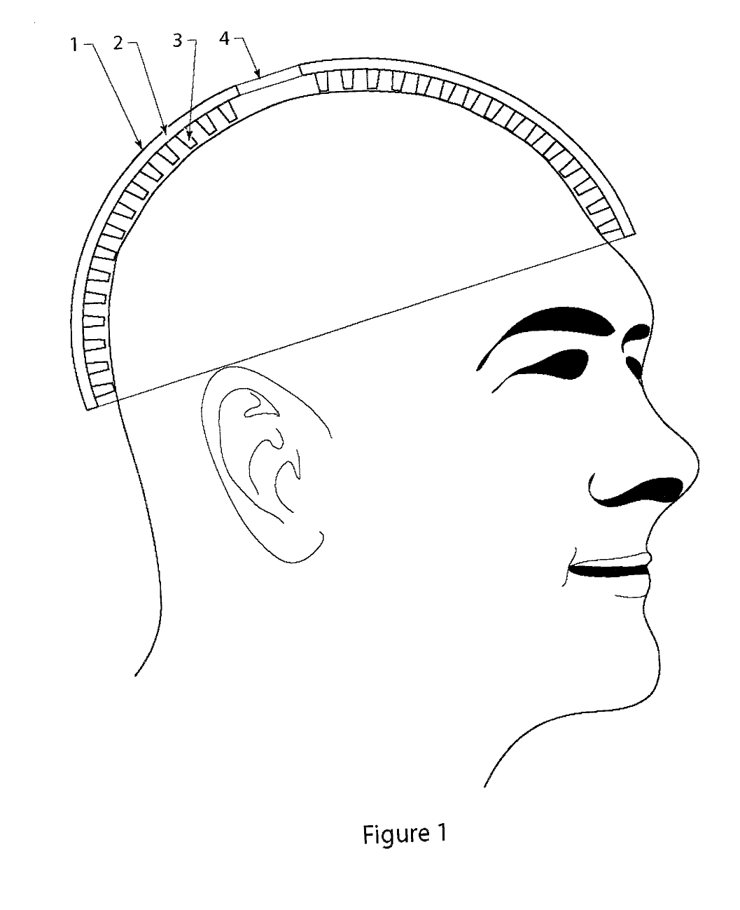

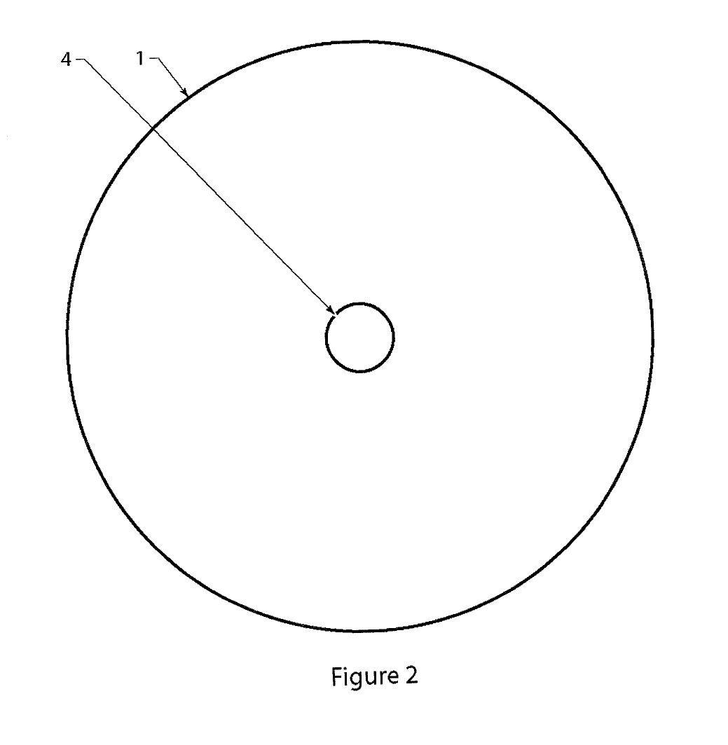

FIG. One (1) illustrates a perspective view of the preferred embodiment of the Invention in use, consisting of an outer surface 1, an flexible and resilient body 2 with numerous tines 3 and a central hole 4. The implement is placed over a human subject's head, as shown in the perspective view of FIG. 1.

In one method of use, the following steps are taken:

i) the user first applies a desired amount of shampoo, conditioner, other hair products, or massage or scalp solutions into the hair,

ii) the cap is placed over the subject's head such that the inner surface of the cap is facing the head, enabling the affixed tines 3 to directly contact the head, hair (if any) and scalp, and the outer surface 1 is facing away from the scalp, so that a large part of the surface area of the head is engaged, substantially from the front to the back hairline, and from ear over top to the other ear;

iii) the hands and fingers of the user, who may be the same human wearing the cap or another assisting the subject (for example, a parent washing a child's hair or a masseuse massaging a patient's head), are placed on the cap's outer surface 1 and moved with the outer surface 1 in a natural manner usually employed in lathering and washing the hair or massaging the scalp;

iv) pressure from the hands and fingers on the outer surface 1 presses the tines 3 to the hair and the scalp;

v) movements of the tines 3 will result at various times and locations from the interaction of frictional forces incurred by the washing movements with resilience and flexibility of the tines 3 as they deform and rebound, so as to incur internal bending moments and the tines 3 thus act slidably against the scalp

vi) pressing of the hands and fingers on to the outer surface 1 causes the tines 3 to stretch, pinch and manipulate the head, hair and scalp to cleanse the scalp by removing dirt, dandruff and accumulated oils and dirt and other buildup, and providing a massage and stimulation of the head, hair and scalp of the subject human.

When finished using the Invention, the user may rinse the Invention by running water over the outer surface 1 and then flipping or reversing the Invention and running water over the inner surface and tines, such that the water drains through the center hole 4. Once complete, the Invention may be stored and dried by hanging the Invention by placing center hole 4 over a hook or other hanger.

FIGS. Two (2) and Three (3), respectively provide a top and bottom elevation of an embodiment of the Invention, being a cap-shaped shell with its outside surface comprising a non-slip surface, its internal surface populated with numerous tines 3, provided in the preferred embodiment with a center hole 4, and being comprised over-all of a resilient and flexible, water and chemical-resistant material which is safe for human use.

The Invention is essentially a hemispherical or bowl-shaped or cap-shaped flexible hollow shell with a circumference of sufficient size to be placed over various sizes and shapes of human heads.

The base diameter of the Invention is substantially round and is roughly eight inches in order to enable the Invention to fit numerous users and to still be used effectively.

The curvature of the Invention is roughly hemispherical, such that it will accommodate different sizes and shapes of heads, and so that it will rest comfortably on the user's head without requiring the user to hold it in place, and about four inches in height.

The relatively loose fit also permits for easier manipulation of the Invention, and a “one-size-fits-all” design.

The roughly 4 inch height or depth C at FIG. 4, and approximately 8 inch diameter B of the cap-like device have been found by experimentation to be preferred.

The body of the Invention is of a material and of such a thickness as to stabilize the tines 3 radially inward to the subject's head, while permitting the tines 3 to contact the head, hair and scalp without extensive pressure being required to be applied to the outer surface 1, and without inhibiting the efficient mobility of the tines 3. It is preferred that the body's material be flexible, resilient, durable, non-porous and easy to clean, odor-free, and safe for use on or near human skin.

The outer surface 1 consists of a non-slip or textured non-abrasive yet easy-to-clean finish, so as to allow the hands and fingers of the user, even when wet and slippery, to maintain control and grip the outer surface 1 during use. A hand strap (not shown) may also be attached to the outer surface 1 to provide additional ease of use or to provide a hanger.

FIG. Four (4) illustrates a cross-sectional view of an embodiment of the Invention. Tines 3 extend throughout the area of the inner surface of the cap, pointing radially inward. There may be eight to sixteen tines 3 per square inch of the inner surface area, which from experimentation provides the most ease of use and effectiveness of operation.

The tines 3 may be different from one type of cap to another, but must be of sufficient spacing, length, shape and density, and with various tip designs, as to be suitable for differing thickness of hair and differing main desired effects. In the preferred embodiment, the tine shapes are the same through the entire inner surface area, but that is not necessary and should not limit the scope of the claims. Tine shapes may include without limitation: truncated conical 3a, conical with suction tip 3b, conical with rounded tip 3c, cylindrical 3d, conical with pointed tip 3e, truncated conical with addition of two or more protrusions on tip 3f, triangular with fused base 3g, cylindrical with balled tip 3h and conical with balled tip 3i. It can be seen that these shapes are exemplary and not limiting to the scope of the invention.

The spacing between the tines 3 is such that it is easy to clean and disengage trapped soap and other debris from the inner surface 5 and the base of the tines 3. The tines 3 are flexible and have various ends for differing configurations. The tines 3 may be affixed to or be formed in one piece with the shell of the cap, and the tines 3 may be disposed in an even array of one tine type, or in differing patterns of differing sizes and shapes of tines, depending upon the effects desired. For example, the ends of the tine may be cupped free ends for enhancing adherence of the tines 3 to the scalp, or may have two or more tips on the end to enhance the massage and stimulation effects of the tines 3.

It is preferred that the tines be spaced apart from one another at their bases 5 to permit ease of cleaning of the cap device and reduce accumulation of soap or other agents, debris, dirt or other matter after use.

The tines 3 in the preferred embodiment have a length or height extending from the inner surface of the cap to the tip of the tine of somewhere between one quarter inch to three quarters of an inch and have a base diameter between one eight of an inch and half an inch and are regularly shaped and disposed within the cap.

The center hole 4 is located roughly at the peak of the cap, and is there to drain water from the Invention, for rinsing, and for determining placement on the user's head by permitting the user to push at least one finger through the hole to touch the scalp, as well as for permitting the Invention to be hung on a hook or other thing for storage and drying. The hole 4 is of such diameter, around one inch in the preferred embodiment, to permit efficient draining of fluid from the cap and such that it may be easily manually covered (by a single hand) so that the Invention can function as a scoop or bucket for use while bathing.

In the foregoing descriptions, the Invention has been described in known embodiments. However, it will be evident that various modifications and changes may be made without departing from the broader scope and spirit of the Invention. Accordingly, the present specifications and embodiments are to be regarded as illustrative rather than restrictive.

The descriptions here are meant to be exemplary and not limiting. It is to be understood that a reader skilled in the art will derive from this descriptive material the concepts of this Invention, and that there are a variety of other possible implementations; all components used in the Invention may be comprised of any suitable material or materials and substitution of different specific components for those mentioned here will not be sufficient to differ from the Invention described where the substituted components are functionally equivalent.

1. a cap-like device for use in manually cleaning, massaging or stimulating human head, hair or scalp comprising a flexible and resilient bowl-shaped body with its inner surface lined with flexible tines.

2. the invention provided in claim 1 where said body has a non-slip outer surface

3. the invention provided in claim 1 with a hole in its center or peak

4. the invention provided in claim 1 with a base diameter of approximately 8 inches and an overall height from base to peak of approximately 4 inches

5. the invention provided in claim 1 with flexible tines evenly arrayed

6. the invention provided in claim 1 with flexible tines arrayed in an uneven pattern of desirable configuration for particular uses

7. the invention provided in claim 1 with flexible and resilient body sufficiently stable to provide support to the included tines such that said tines maintain their radially inward-pointing attitude while in use

8. the invention provided in claim 1 made in one piece

9. the invention provided in claim 1 where said tines are later affixed to said body

10. the invention provided in claim 1 where there is between the base of each tine and tines adjacent to each tine space on the inner surface of said body such that matter less easily sticks to said device after use
